(19) United States
(12) Patent Application Publication
(10) Pub. No.: US 2025/0143415 A1
(43) Pub. Date: May 8, 2025

(54) ATTACHABLE/DETACHABLE DEVICE FOR SUPPORTING BAND

(71) Applicant: Samsung Electronics Co., Ltd., Suwon-si (KR)

(72) Inventor: Kuemjong BAE, Suwon-si (KR)

(21) Appl. No.: 19/002,339

(22) Filed: Dec. 26, 2024

Related U.S. Application Data
(63) Continuation of application No. PCT/KR2023/008693, filed on Jun. 22, 2023.

(30) Foreign Application Priority Data
Aug. 3, 2022 (KR) 10-2022-0096906
Sep. 5, 2022 (KR) 10-2022-0112317

(51) Int. Cl. A44B 11/26; B25J 9/00

(52) U.S. Cl. CPC A44B 11/26; B25J 9/0006; A44D 2203/00

(57) ABSTRACT

An attachable/detachable device for supporting a band of a device, such as a wearable walking assist device, may include a base plate, a base protrusion, a base frame, a locking magnet, and a button comprising a slider, a slider magnet, a button cover, a button cap, and a spring, the button being attachable to/detachable from the base frame. Various other embodiments are possible.

### CROSS-REFERENCE TO RELATED APPLICATIONS

This application is a continuation application of International Application No. PCT/KR2023/008693 designating the United States, filed on Jun. 22, 2023, in the Korean Intellectual Property Receiving Office and claiming priority to Korean Patent Application No. 10-2022-0029132, filed on Aug. 3, 2022, and to Korean Patent Application No. 10-2022-0112317, filed on Sep. 5, 2022, in the Korean Intellectual Property Office, the disclosures of which are all hereby incorporated by reference herein in their entireties.

### BACKGROUND

### 1. Field

Certain example embodiments relate to detachable device for supporting a band.

### 2. Description of Related Art

A motion assistance device refers to a mechanism or a device that helps a patient or other person, who cannot walk on their own due to various diseases, accidents, and the like, or a person who desires to exercise, to perform exercises for rehabilitation treatment or any other purpose. With the recent intensifying aging societies, a growing number of people experience inconvenience in exercising or have difficulty in normal exercising due to malfunctioning joint issues, and there is increasing interest in motion assistance devices. An exercise assistance device is configured to be worn on a body of a user to help the user exercise by providing a necessary muscular strength that allows the user to walk so that the user may exercise normally or otherwise.

In general, users wearing a motion assistance device may be people with physical disabilities for example. For these people, the process of putting on an exercise assistance device itself may be difficult. There is a demand for a technique to help a user with physical disabilities wear a motion assistance device without the help of other people.

The above description is information the inventor(s) acquired during the course of conceiving the present disclosure, or already possessed at the time, and is not necessarily art publicly known before the present application was filed.

### SUMMARY

According to an example embodiment, a detachable device for supporting a band may include a base plate, a base protrusion protruding from the base plate, a base frame disposed on, directly or indirectly, the base plate and accommodating the base protrusion, a locking magnet disposed on, directly or indirectly, the base frame, and a button provided detachably from the base frame and including a support frame disposed on, directly or indirectly, the base frame, a slider slidable along the support frame, a slider magnet disposed on, directly or indirectly, the slider and facing the locking magnet, a button cover covering the slider, a button cap slidable along the button cover and moving the slider, and a spring provided between the button cover and the button cap.

In an example embodiment, while the support frame and the button cover are fixed in relative positions to the base frame, the slider and the button cap may move relative to the base frame.

In an example embodiment, the slider may include a slider body slidable along the support frame, and a slider hole formed through the slider body and including a slider hole for accommodating the base protrusion.

In an example embodiment, the slider hole may include an elongated shape in a direction away from the base frame.

In an example embodiment, the slider hole may include a shape that narrows as the slider hole moves away from the base frame.

In an example embodiment, the slider hole may include an unlocking hole provided to pass the base protrusion therethrough, and a locking hole extending from the unlocking hole in a direction away from the base frame and having a smaller size than the unlocking hole.

In an example embodiment, the base protrusion may include a base protrusion body protruding from the base plate, and a base protrusion head connected to the base protrusion body and having a thicker thickness than the base protrusion body.

In an example embodiment, while the base protrusion body is positioned in the locking hole, the base protrusion head may overlap the slider body.

In an example embodiment, the slider may further include a slider guide protruding from the slider body, accommodating at least a portion of the button cap, and interfering with the button cap.

In an example embodiment, the base frame may include a frame body disposed on, directly or indirectly, the base plate, a frame head extending from the frame body, and a frame hole formed through the frame body and accommodating the base protrusion.

In an example embodiment, the frame body may include a main body part including a hollow therein, and a magnet housing protruding outwardly from the main body part and accommodating the locking magnet.

In an example embodiment, the button may further include an unlocking magnet disposed on, directly or indirectly, the support frame and applying a magnetic force to the slider.

In an example embodiment, the button cap may include a cap main plate covering the button cover, and a cap guide protrusion protruding toward the support frame from the cap main plate and interfering with the slider.

In an example embodiment, the button cap may further include a cap pressing protrusion protruding toward the support frame from the cap main plate, spaced apart from the cap guide protrusion, and pressing one end of the spring.

### BRIEF DESCRIPTION OF DRAWINGS

FIG. 1 is a perspective view illustrating a user wearing a motion assistance device according to an example embodiment.

FIG. 2 is a perspective view illustrating a detachable device for supporting a band according to an example embodiment.

FIG. 3 is an exploded perspective view illustrating a detachable device for supporting a band according to an example embodiment.

FIG. 4 is a perspective view of a button cap according to an example embodiment.

FIG. 5 is a perspective view illustrating the inside of a detachable device for supporting a band according to an example embodiment.

FIG. 6 is a cross-sectional view illustrating a detachable device for supporting a band according to an example embodiment.

FIG. 7 is a perspective view illustrating the inside of a detachable device for supporting a band according to an example embodiment.

FIG. 8 is a cross-sectional view illustrating a detachable device for supporting a band according to an example embodiment.

FIG. 9 is a cross-sectional view illustrating a detachable device for supporting a band according to an example embodiment.

FIG. 10 is a cross-sectional view illustrating a detachable device for supporting a band according to an example embodiment.

### DETAILED DESCRIPTION

The following detailed structural or functional description is provided as an example only and various alterations and modifications may be made to certain example embodiments. Accordingly, the embodiments are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a “first” component may be referred to as a “second” component, and similarly, the “second” component may be referred to as the “first” component.

It should be noted that if it is described that one component is “connected”, “coupled”, or “joined” to another component, at least a third component may be “connected”, “coupled”, and “joined” between the first and second components, although the first component may be directly connected, coupled, or joined to the second component. Thus, for example, “connected” as used herein covers both direct and indirect connections.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

The same name may be used to describe an element included in the embodiments described above and an element having a common function. Unless otherwise mentioned, the descriptions of the embodiments may be applicable to the following embodiments, and thus duplicated descriptions will be omitted for conciseness.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

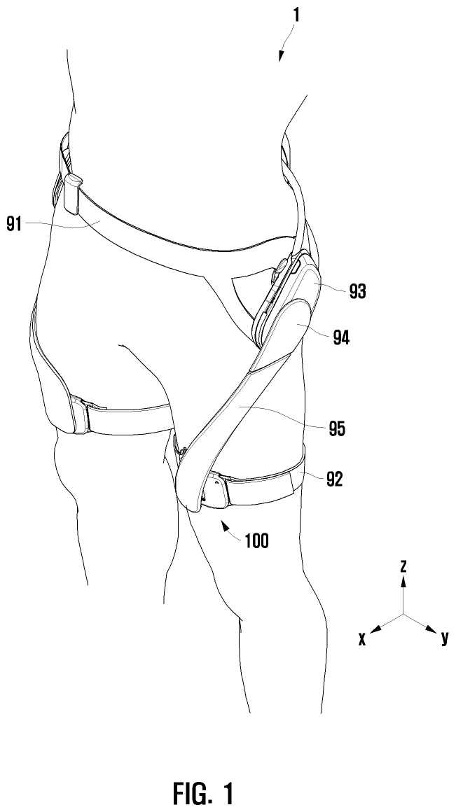

FIG. 1 is a perspective view illustrating a user wearing a motion assistance device according to an embodiment.

Referring to FIG. 1, a motion assistance device 1 may be worn by a user and may assist a motion of the user. The user may be a human, an animal, or a robot, but is not limited thereto. The motion assisting device 1 may assist a motion of some upper or lower body joints of the user. For example, the motion assist apparatus 1 may assist the motion of the lower body of the user by assisting at least one of a hip joint, a knee joint, and an ankle joint of the user. For example, the motion assisting device 1 may assist the motion 20 of the upper body of the user by assisting at least one of a shoulder joint, an elbow joint, and a wrist joint of the user. The motion assisting device 1 may assist the user in walking by assisting the motion of some lower body joints of the user. Hereinafter, the description is provided on the motion assist apparatus 1 assisting the user in walking by assisting the motion of the hip joint of the user, but a wearing part and a target joint of the motion assist apparatus 1 are not limited thereto. The motion assistance device 1 may include a proximal support 91, a distal support 92, an actuator 93, an upper frame 94, a lower frame 95, and a detachable device 100. The proximal support 91 and the distal support 92 may each include a band.

In an embodiment, the proximal support 91 and the distal support 92 may be disposed opposite to each other based on a body part of the user and may respectively support a proximal part and a distal part. For example, the proximal support 91 may support a waist and/or a pelvis of the user and the distal support 92 may support a thigh, a knee, a calf, and/or a foot of the user. The proximal support 91 may include a detachable band for supporting the waist of the user all around. The distal support 92 may include a detachable band for supporting the thigh of the user all around.

As another example, the proximal support 91 and the distal support 92 may be opposite to each other based on the upper arm of the user. In this case, the proximal support 91 may support a shoulder and/or a back of the user and the distal support 92 may support a forearm of the user. For example, the proximal support 91 may include a detachable belt for supporting the shoulder of the user all around and the distal support 92 may include a detachable belt for supporting the forearm of the user all around or a structure enclosing the forearm of the user all around.

In an embodiment, the proximal support 91 and the distal support 92 may move relative to each other on a sagittal plane. For example, in the case of hip joint flexion or extension while the user wears the motion assistance device 1, the distal support 92 may rotate relative to the proximal support 91 on the sagittal plane.

In an embodiment, the proximal support 91 and the distal support 92 may move relative to each other on a frontal plane. For example, in the case of hip joint adduction or abduction while the user wears the motion assistance device 1, the distal support 92 may rotate relative to the proximal support 91 on the frontal plane.

In an embodiment, the lower frame 95 and the distal support 92 may move relative to each other on a transverse plane. For example, when the user rotates their thigh while wearing the motion assistance device 1, the distal support 92 may rotate together with the thigh of the user while being in close contact with the thigh. The distal support 92 may rotate relative to the lower frame 95. In this structure, the wearability felt by the user may be improved.

In an embodiment, the actuator 93 may be connected to the proximal support 91 and may generate power. The actuator 93 may include, for example, a motor and a speed reducer. The motor may include at least one of a brush motor, a brushless motor, and a stepping motor. The motor may include at least one of an induction motor and a synchronous motor. The speed reducer may include, for example, a gear train.

In an embodiment, the upper frame 94 and the lower frame 95 may transmit the power generated by the actuator 93 to the distal support 92. For example, the upper frame 94 and the lower frame 95 may assist a hip joint motion of the user. The upper frame 94 may be detachably provided at the actuator 93. For example, the upper frame 94 may be coupled to an outer surface of the actuator 93. The lower frame 95 may be rotatably connected to the upper frame 94 and may be connected to the distal support 92. The lower frame 95 may have a shape that covers a portion of the distal part of the user. For example, the lower frame 95 may cover a portion of the thigh of the user. The length of the lower frame 95 may be greater than the length of the upper frame 94.

In an embodiment, when an output end of the actuator 93 rotates in one direction, the upper frame 94 and the lower frame 95 may assist flexion of the hip joint by receiving power from the actuator 93 and transmitting the power to the distal support 92. For example, when the output end of the actuator 93 rotates in a clockwise direction, the upper frame 94 and the lower frame 95 may assist flexion of the hip joint.

In an embodiment, when the output end of the actuator 93 rotates in an opposite direction, the upper frame 94 and the lower frame 95 may assist extension of the hip joint by receiving power from the actuator 93 and transmitting the power to the distal support 92. For example, when the output end of the actuator 93 rotates in a counterclockwise direction, the upper frame 94 and the lower frame 95 may assist extension of the hip joint.

In an embodiment, it is described that the upper frame 94 and the lower frame 95 assist the hip joint motion. However, the functions of the upper frame 94 and the lower frame 95 are not limited thereto. For example, when the motion assistance device 1 is used to assist the motion of an upper body joint, the upper frame 94 and the lower frame 95 may assist a shoulder or elbow joint.

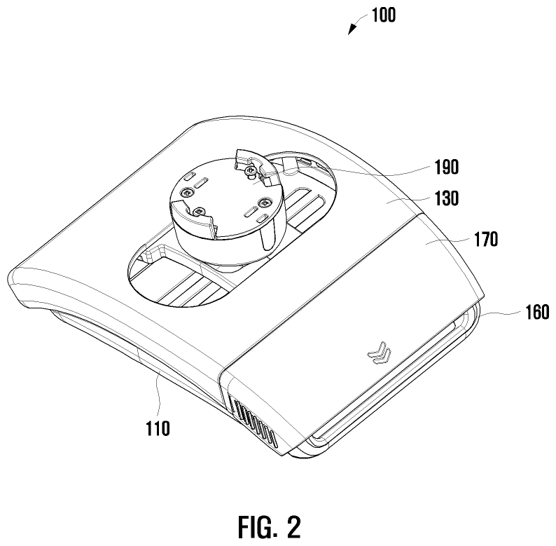

FIG. 2 is a perspective view illustrating a detachable device for supporting a band according to an embodiment.

Referring to FIG. 2, a detachable device 100 for supporting a band (hereinafter, referred to as a “detachable device”) according to an embodiment may have a structure that is easily detachable from each other. A detachable device 100 may support a band (not shown). In this case, the band may be the distal support 92 shown in FIG. 1. For example, the band may be formed of an elastic material. For example, the band may include a rubber material. For example, the band may be formed of an inelastic material. For example, the band may include a synthetic fiber material. One end of the band may be connected to one side of the detachable device 100, and the other end of the band may be connected to the other side of the detachable device 100. The detachable device 100 and the band may enclose a body part of the user. For example, the detachable device 100 and the band may enclose the thigh of the user. It shall be noted that positions at which the detachable device 100 and the band are worn are not limited thereto.

The detachable device 100 may include a base plate 110, a base frame 130, a button cover 160, a button cap 170, and a connection member 190.

The base plate 110 and the base frame 130 may be assembled to each other. A hollow may be provided inside the base plate 110 and the base frame 130. The base frame 130 may include one end of the band.

The button cover 160 may be provided parallel with the base frame 130. The button cover 160 may be provided detachably from the base plate 110 and the base frame 130. The button cover 160 may support the other end of the band.

The button cap 170 may switch a connection state of the button cover 160. For example, when an external force is not applied to the button cap 170, the button cover 160 may be coupled to the base plate 110 and the base frame 130. When the external force is applied to the button cap 170, the button cap 170 may move. For example, the button cap 170 may slide along the button cover 160. For example, the user may apply the external force to the button cap 170 with a finger while gripping the button cap 170.

The connection member 190 may be accommodated in the base plate 110 and the base frame 130. The connection member 190 may slide inside the base plate 110 and the base frame 130.

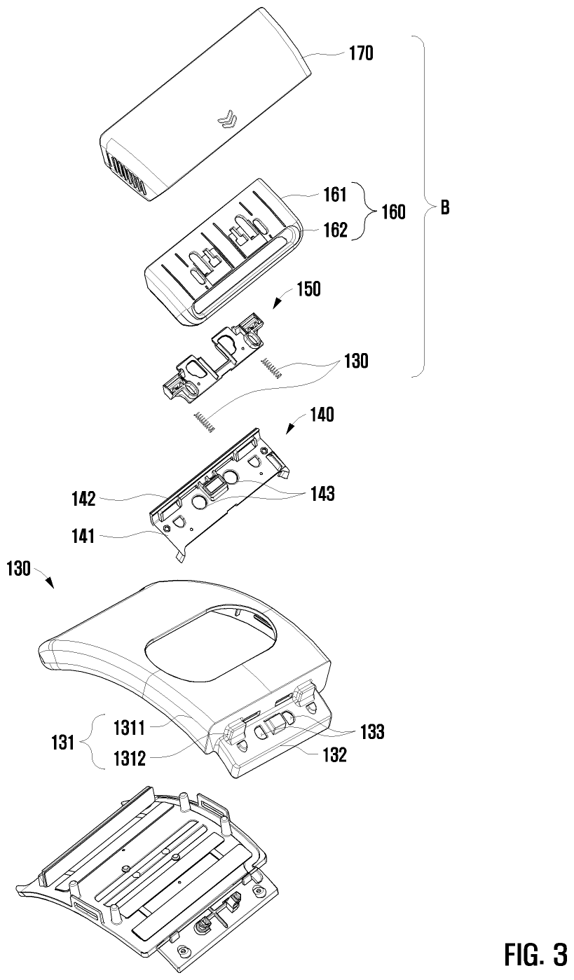

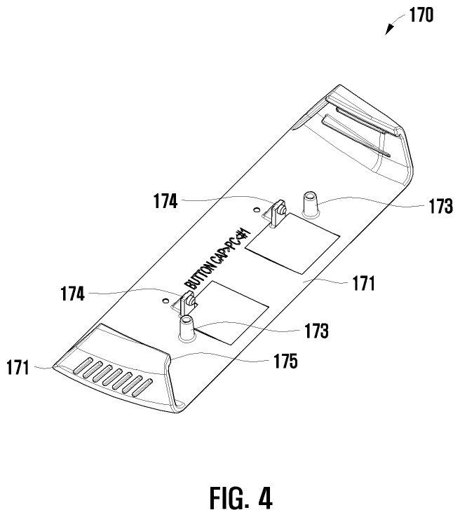

FIG. 3 is an exploded perspective view illustrating a detachable device for supporting a band according to an embodiment, and FIG. 4 is a perspective view of a button cap according to an embodiment.

Referring to FIGS. 3 and 4, the detachable device 100 may include the base plate 110, a base protrusion 120, the base frame 130, and a button B. The base plate 110, the base protrusion 120, and the base frame 130 may be assembled. The base plate 110, the base protrusion 120, and the base frame 130 may be separately manufactured and may be assembled. At least one of the base plate 110, the base protrusion 120, and the base frame 130 may be integrally formed as one.

The base plate 110 may face a body part of the user. For example, a rear surface of the base plate 110 may face the body of the user, and a front surface of the base plate 110 may support the base frame 130. The base plate 110 may include a curved surface to fit more closely to the body of the user. The base plate 110 may include a main part and a sub-part. The main part of the base plate 110 may have a relatively large area and may support a frame body 131 to be described below. The sub-part of the base plate 110 may have a relatively small area and may support a frame head 132 to be described below.

The base protrusion 120 may protrude from the base plate 110. For example, the base protrusion 120 may be formed in the sub-part of the base plate 110. The base protrusion 120 may have a shape that protrudes in an upper direction. In this case, the upper direction may be an upper direction based on FIG. 3. The upper direction may be a direction away from the body part of the user based on a state in which the detachable device is worn on the body part of the user. A plurality of base protrusions 120 may be provided. In the drawings, two base protrusions 120 are illustrated, but the example is not limited thereto. The plurality of base protrusions 120 may be spaced apart from each other. The base protrusion 120 may pass through the base frame 130.

The base frame 130 may be disposed on, directly or indirectly, the base plate 110. The base frame 130 may include the frame body 131 disposed on, directly or indirectly, the base plate 110, the frame head 132 extending from the frame body 131, and a frame hole 133 formed through the frame head 132. The frame hole 133 may accommodate the base protrusion 120.

The frame body 131 may include a main body part 1311 including a hollow therein, and a magnet housing 1312 protruding outwardly from the main body part 1311. The magnet housing 1312 may include a locking magnet (not shown) to be described below. The detachable device may secure a large size of a hollow area of the main body part 1311 by separately including the magnet housing 1312.

The button B may be detachable from the base plate 110, the base protrusion 120, and the base frame 130. The button B may include a support frame 140, a slider 150, the button cover 160, the button cap 170, and a spring 180. The button B may be integrally provided as a single unit. For example, the detachable device 100 may include two units. Specifically, the base plate 110, the base protrusion 120, and the base frame 130 may function as one unit, and the button B may function as another unit. The units may be detachable from each other.

The support frame 140 may be disposed, directly or indirectly, on the base frame 130. The support frame 140 may be disposed on, directly or indirectly, the frame head 132. The support frame 140 may be detachable from the frame head 132. The support frame 140 may be in surface contact with the frame head 132. The support frame 140 may include a horizontal plate 141 disposed on, directly or indirectly, the frame head 132, a vertical plate 142 connected to the horizontal plate 141 and facing the frame body 131, and a plate hole 143 for accommodating the base protrusion 120.

The slider 150 may slide along the support frame 140. The slider 150 may interfere with the button cap 170. The slider 150 may move by receiving an external force from the button cap 170. A gap may be provided between the slider 150 and the button cap 170, and thereby, the slider 150 may move relative to the button cap 170 to a predetermined degree. For example, even when the button cap 170 is fixed, the slider 150 may move along the support frame 140.

The button cover 160 may cover the slider 150. The button cover 160 may support the other end of the band (not shown). The button cover 160 may include a cover body 161 accommodating the slider 150, and a cover arm 162 protruding from the cover body 161.

The button cap 170 may slide along the button cover 160. The button cap 170 may apply an external force to the slider 150.

The spring 180 may be provided between the button cover 160 and the button cap 170. The spring 180 may be transformed by being pressed by the button cap 170. For example, when the button cap 170 slides in a direction away from the base frame 130, the spring 180 may be compressed by the button cover 160 and the button cap 170. For example, while the button cap 170 slides in a direction away from the frame body 131, the slider 150 may slide in a direction away from the frame body 131. A restoring force of the compressed spring 180 may serve as a force to move the slider 150 toward the frame body 131.

When the slider 150 slides in the direction away from the frame body 131, the unlocking magnet (not shown) may exert an attractive force on the slider 150 to assist the slider 150 not to approach the frame body 131 again.

The button cap 170 may include a cap main plate 171, a cap side plate 172, a cap guide protrusion 173, a cap pressing protrusion 174, and a cap rib 175.

The cap main plate 171 may cover an upper portion of the slider 150. The cap side plate 172 may protrude downward from both ends of the cap main plate 171. The cap side plate 172 may cover a side portion of the slider 150. The cap guide protrusion 173 may protrude toward the support frame 140 from the cap main plate 171. The cap guide protrusion 173 may interfere with the slider 150. The cap guide protrusion 173 may move the slider 150 in a first direction. For example, the first direction may be a direction away from the frame body 131. Additionally, the slider 150 may return the button cap 170 to its original position while the slider 150 moves in a second direction. In this case, the second direction may be a direction opposite to the first direction. For example, the slider 150 may return to its original position by the restoring force of the spring 180. As the slider 150 moves, the slider 150 may press the cap guide protrusion 173, and the button cap 170 may move in the second direction by the force. The cap pressing protrusion 174 may protrude from the cap main plate 171 and may be spaced apart from the cap guide protrusion 173. The cap pressing protrusion 174 may press the spring 180. For example, an end of the spring 180 may be pressed by the cap pressing protrusion 174, and the other end of the spring 180 may be pressed by an inner surface of the button cover 160. The inner surface of the button cover 160 may be a surface facing the cap pressing protrusion 174. The cap rib 175 may protrude inwardly from the cap side plate 172. The cap rib 175 may be formed on a surface of the cap side plate 172 facing the cap guide protrusion 173. The cap rib 175 may assist the button cap 170 to maintain a state in which the button cap 170 is stably supported by the button cover 160 and the support frame 140. For example, the cap rib 175 may prevent or reduce chances of the button cap 170 from being separated from the button cover 160.

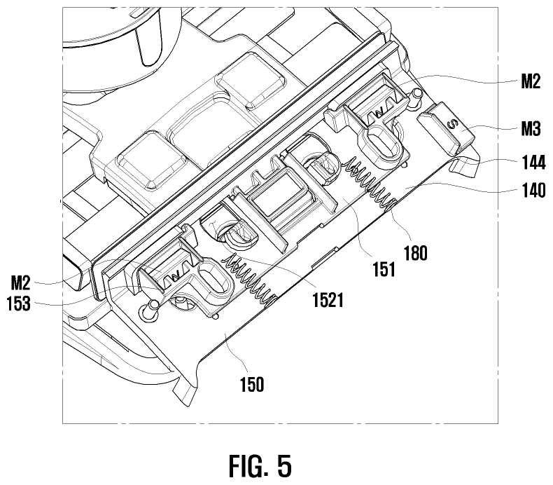

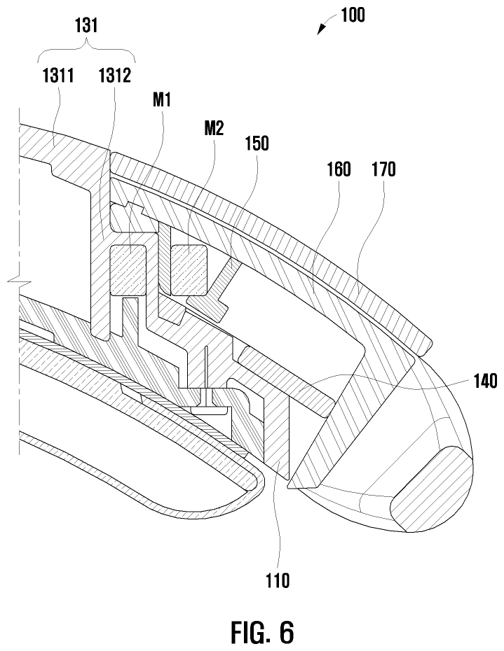

FIG. 5 is a perspective view illustrating the inside of a detachable device for supporting a band according to an embodiment, and FIG. 6 is a cross-sectional view illustrating a detachable device for supporting a band according to an embodiment. FIGS. 5 and 6 illustrate a state in which a button is mounted on a base frame.

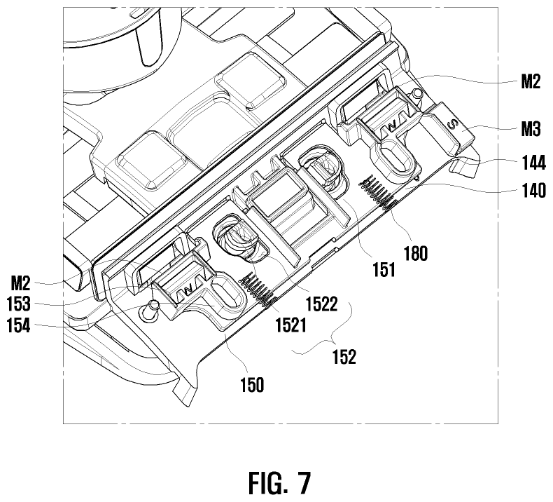

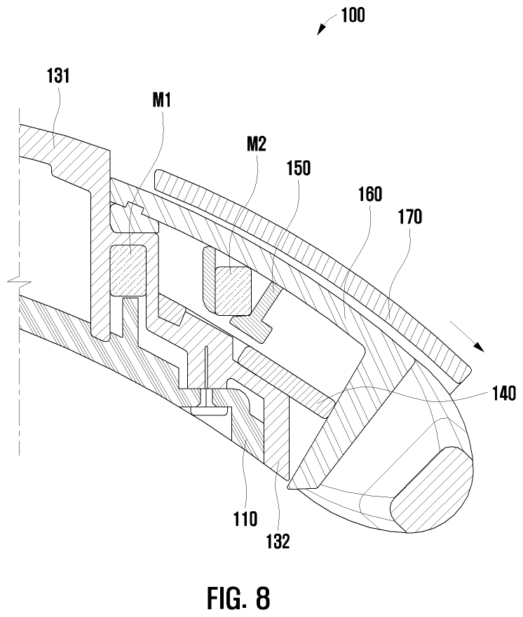

FIG. 7 is a perspective view illustrating the inside of a detachable device for supporting a band according to an embodiment, and FIG. 8 is a cross-sectional view illustrating a detachable device for supporting a band according to an embodiment. FIGS. 7 and 8 illustrate a state in which a button is ready to be released from a base frame.

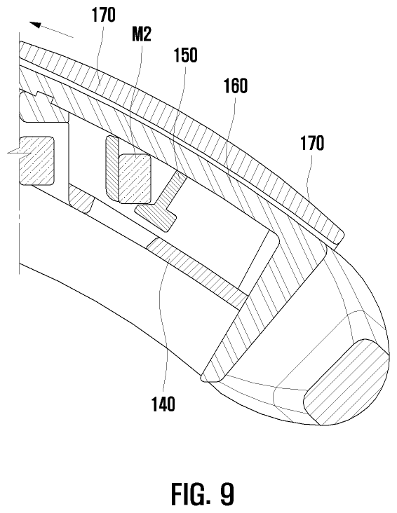

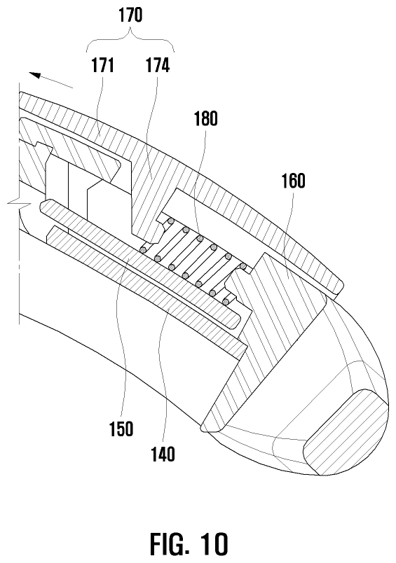

FIG. 9 is a cross-sectional view illustrating a detachable device for supporting a band according to an embodiment, and FIG. 10 is a cross-sectional view illustrating a detachable device for supporting a band according to an embodiment. FIGS. 9 and 10 illustrate a button separated from a base frame.

Referring to FIGS. 5 to 10, a one-touch detachment structure may include the base frame 130, the base plate 140, the slider 150, a locking magnet M1, a slider magnet M2, and an unlocking magnet M3.

The base frame 130 may include the frame body 131 and the frame head 132. The frame body 131 may include the main body part 1311 including a hollow, and the magnet housing 1312 accommodating the locking magnet M1.

The base plate 140 may include a support housing 144. The support housing 144 may support the unlocking magnet M3. The unlocking magnet M3 may exert an attractive force on the slider magnet M2. The unlocking magnet M3 may apply a magnetic force to the slider 150 to move the slider 150 in a direction away from the base frame 130. The magnetic force applied between the locking magnet M1 and the slider magnet M2 may be offset to a predetermined degree by the unlocking magnet M3.

The slider 150 may slide along the base plate 140. The slider 150 may include a slider body 151, a slider hole 152, a slider body housing 153, and a slider guide 154.

The slider hole 152 may have an elongated shape in a direction away from the frame body 131. The longitudinal direction of the slider hole 152 may be formed in a direction away from the frame body 131. The slider hole 152 may include a shape that narrows as the slider hole 152 moves away from the frame body 131. The slider hole 152 may include an unlocking hole 1521 and a locking hole 1522. The unlocking hole 1521 and the locking hole 1522 may be connected to each other.

The unlocking hole 1521 may allow the base protrusion to pass through. The unlocking hole 1521 may have a relatively large size. The unlocking hole 1521 may have a larger size than a base protrusion head of the base protrusion. When the base protrusion is positioned parallel with the unlocking hole, the button may be separated from the base frame 130 as the button moves upward.

The locking hole 1522 may have a smaller size than the unlocking hole 1521 in a direction away from the frame body 131. The locking hole 1522 may have a smaller size than the base protrusion head of the base protrusion. When the base protrusion is positioned parallel with the locking hole 1522, even if the button moves upward, the support frame 140 may be caught by the base protrusion.

When the button cap 170 moves in the direction away from the frame body 131, at least a portion of the button cap 170 may press the slider guide 154 while being inserted into the slider guide 154. The slider 150 pressed by the button cap 170 may move in the direction away from the frame body 131.

While the button is separated from the base frame, the button cap 170 may slide along the button cover 160 by the restoring force of the spring 180.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

Therefore, other implementations, other embodiments, and/or equivalents of the claims are within the scope of the following claims.

1. A detachable device for supporting a band, the detachable device comprising:
a base plate;
a base protrusion protruding from the base plate;
a base frame disposed on the base plate and at least partially accommodating the base protrusion;
a locking magnet disposed on the base frame; and
a button provided detachably from the base frame and comprising a support frame disposed on the base frame, a slider configured to be slidable along the support frame, a slider magnet disposed on the slider and at least partially facing the locking magnet, a button cover covering at least part of the slider, a button cap configured to be slidable along the button cover and moving the slider, and a spring provided between at least the button cover and the button cap.

2. The detachable device of claim 1,
wherein, while the support frame and the button cover are fixed in relative positions to the base frame, the slider and the button cap are configured to move relative to the base frame.

3. The detachable device of claim 1,
wherein the slider comprises:
a slider body slidable along the support frame; and
a slider hole formed through the slider body and comprising a slider hole for accommodating at least part of the base protrusion.

4. The detachable device of claim 3,
wherein the slider hole comprises an elongated shape in a direction away from the base frame.

5. The detachable device of claim 4,
wherein the slider hole comprises a shape that narrows as the slider hole moves away from the base frame.

6. The detachable device of claim 4,
wherein the slider hole comprises:
an unlocking hole configured to pass the base protrusion therethrough; and
a locking hole extending from the unlocking hole in a direction away from the base frame and having a smaller size than the unlocking hole.

7. The detachable device of claim 6,
wherein the base protrusion comprises:
a base protrusion body protruding from the base plate; and
a base protrusion head connected to the base protrusion body and having a larger thickness than the base protrusion body.

8. The detachable device of claim 7,
wherein, the base protrusion is configured so that while the base protrusion body is positioned in the locking hole, the base protrusion head overlaps the slider body.

9. The detachable device of claim 3,
wherein the slider further comprises:
a slider guide protruding from the slider body, accommodating at least a portion of the button cap.

10. The detachable device of claim 1,
wherein the base frame comprises:
a frame body disposed on the base plate, a frame head extending from the frame body, and a frame hole formed through the frame body and accommodating at least part of the base protrusion.

11. The detachable device of claim 10,
wherein the frame body comprises:
a main body part comprising a hollow therein; and
a magnet housing protruding outwardly from the main body part and accommodating at least part of the locking magnet.

12. The detachable device of claim 1,
wherein the button further comprises an unlocking magnet disposed on the support frame and configured to apply a magnetic force to the slider.

13. The detachable device of claim 1,
wherein the button cap comprises:
a cap main plate covering the button cover; and
a cap guide protrusion protruding toward the support frame from the cap main plate.

14. The detachable device of claim 13,
wherein the button cap further comprises:
a cap pressing protrusion protruding toward the support frame from the cap main plate, spaced apart from the cap guide protrusion, and configured for pressing an end of the spring.

15. A wearable walking assist device, including a detachable device for supporting a band, the wearable walking assist device comprising:
a proximal support configured to be worn proximate a waist of a user;
a distal support configured to be worn on a leg of the user;
the detachable device configured to support a band of the proximal support and/or the distal support; wherein the detachable device comprises:
a base plate;
a base protrusion protruding from the base plate;
a base frame disposed on the base plate and at least partially accommodating the base protrusion;
a locking magnet disposed on the base frame; and
a button provided detachably from the base frame and comprising a support frame disposed on the base frame, a slider configured to be slidable along the support frame, a slider magnet disposed on the slider and facing the locking magnet, a button cover covering the slider, a button cap configured to be slidable along the button cover and moving the slider, and a spring provided between at least the button cover and the button cap.
